(19) United States
(12) Patent Application Publication
(10) Pub. No.: US 2009/0296913 A1
(43) Pub. Date: Dec. 3, 2009

(54) System and method for location based call processing

(76) Inventors: Eric Thomas, Encinitas, CA (US); Christopher Nikkel, Carlsbad, CA (US); Mike DeSaro, Encinitas, CA (US)

Correspondence Address: GIBBONS P.C., ONE GATEWAY CENTER, NEWARK, NJ, 07102, US

(21) Appl. No.: 12/154,931

(22) Filed: May 28, 2008

(51) Int. Cl. H04M 3/42

(52) U.S. Cl. 379/211.02

(57) ABSTRACT

A method for forwarding calls. In one aspect, the method includes the steps of receiving at a server a first call to a first telephone number, selecting a target telephone number based on a geographic location of a communication device, initiating a second call from the server to the target telephone number, and connecting the first call and the second call.

### BACKGROUND

The present disclosure relates to a system and method for providing a telephone number that may be device independent. More particularly, the present disclosure relates to a system and method that may allow subscribers of a service to receive and place calls using a single telephone number while using telephone devices connected physically or wirelessly to the Public Switched Telephone Network (“PSTN”).

With the advancements in and proliferation of telecommunication technology such as cellular phones, the internet, and wireless computing, people have become increasingly more mobile and able to perform business or personal tasks almost anywhere and at almost any time. As a result, it may be desirable to have a system that simplifies the process of staying in contact with others telephonically.

### SUMMARY

The present disclosure relates to a method for forwarding calls. The method includes the steps of receiving at a server a first call to a first telephone number, selecting a target telephone number based on a geographic location of a communication device, initiating a second call from the server to the target telephone number, and connecting the first call and the second call.

### BRIEF DESCRIPTION OF THE DRAWINGS

Features and other aspects of embodiments of the present invention are explained in the following description taken in conjunction with the accompanying drawings, wherein like references numerals refer to like components, and wherein:

FIG. 1 shows an overview diagram of the system according to an aspect of the system and method of the present disclosure.

FIG. 2 shows a flowchart according to an aspect of the system and method of the present disclosure.

FIG. 3 shows a diagram according to an aspect of the system and method of the present disclosure.

FIG. 4 shows a diagram according to an aspect of the system and method of the present disclosure.

FIG. 5 shows a diagram according to an aspect of the system and method of the present disclosure.

FIG. 6 shows a diagram according to an aspect of the system and method of the present disclosure.

FIG. 7 shows a diagram according to an aspect of the system and method of the present disclosure.

FIG. 8 shows a flowchart according to an aspect of the system and method of the present disclosure.

FIG. 9 shows a flowchart according to an aspect of the system and method of the present disclosure.

FIG. 10 shows a diagram according to an aspect of the system and method of the present disclosure.

### DETAILED DESCRIPTION

The system and method of the present disclosure relates to the use of a telephone number that may be a user-specific subscriber number. Calls to the subscriber telephone number may be forwarded or transferred to candidate telephone numbers, such as the subscriber's home telephone. Candidate telephone numbers and a proposed order of preference for contacting the candidate telephone numbers may be adjusted based on the subscriber's geographic location. For example, when the subscriber is at home, the subscriber's home telephone number may be the highest ranked candidate telephone number. In one aspect of the system and method of the present disclosure, calls placed by the subscriber may show the caller identification of the subscriber telephone number rather than, for example, the phone number of the subscriber's home telephone, thereby allowing the subscriber's home telephone number to remain private. In another aspect, the system and method of the present disclosure also may provide for live calls to be transferred to and from candidate telephone numbers.

In another aspect, the system and method of the present disclosure may receive a phone call on a subscriber phone number and route the call to a destination based on parameters assigned by the subscriber through the client application.

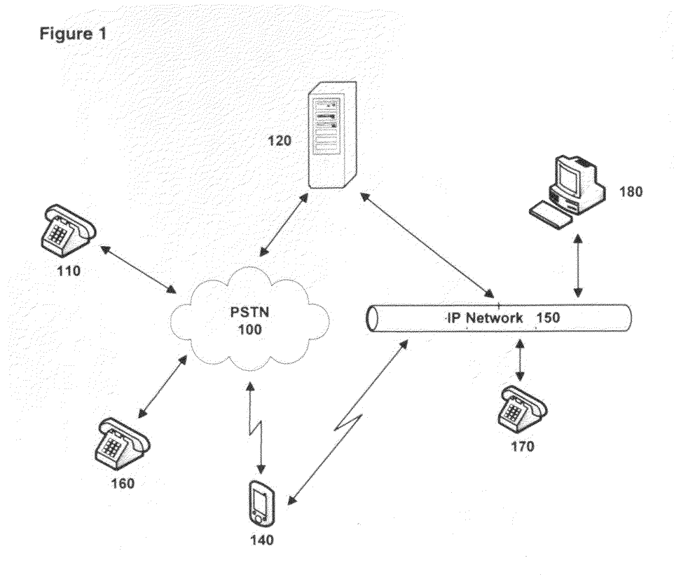

As shown in FIG. 1, the system and method of the present disclosure may interface with the Public Switched Telephone Network (“PSTN”) 100 and the internet or another Internet Protocol (“IP”) based network 150.

The system may receive incoming calls from communication devices 110 that may be routed through the PSTN 100 to Application Server 120. Application Server 120 may include a processing engine (not shown) to receive calls from the PSTN 100; access and store called number or subscriber configuration settings; and route calls back to and place new calls to the PSTN 100. Application Server 120 may include one or more physical computing devices (not shown) such as computer servers with interfaces for connecting to PSTN 100 and IP Network 150. Once an incoming call has been received by Application Server 120, then the call then may be routed to a destination based on the subscriber configuration settings. These destinations may include Portable Communications Devices 140, such as a cellular phone; a telephone or communication device 160 connected to the PSTN 100; or a communication device 170 connected through IP Network 150, such as an analog telephone connected through Analog Telephone Adapter (“ATA”) or Session Initiation Protocol (“SIP”) phones.

Portable Communications Devices 140 such as “smart mobile devices” capable of running mobile operating systems (“OS”) including, but not limited to, iPhone OS, BlackBerry OS, Windows Mobile, Palm OS, and Android, may also communicate through the EP Network 150 to Application Server 120 using a natively running application, also referred here as a device enabled client application, or using a web based application, also referred here as a web browser enabled client application. These applications may retrieve and update configuration settings on Application Server 120 by manual manipulation or automatically by integrating with core services of the portable device including, but not limited to, an address book framework and the device's core location framework used to provide the current latitude and longitude of the device. Web browser enabled client applications may also access Application Server 120 through other devices such as computers 180 connected through the IP Network 150.

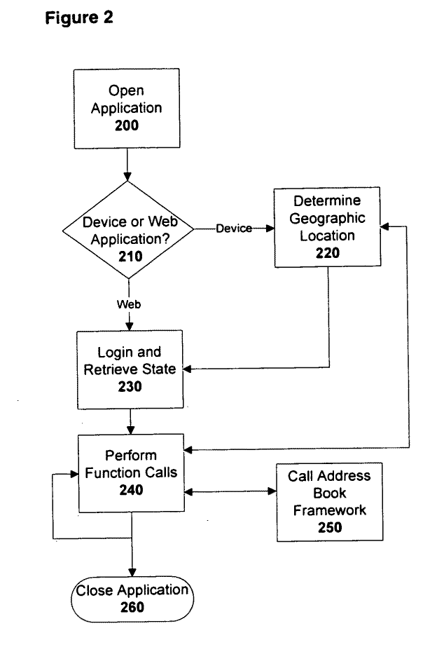

As shown in FIG. 2, the client application may perform various tasks to manage parameters associated with routing incoming calls to the subscriber's telephone number and may include tools to place outbound calls through the subscriber's telephone number. The tasks may differ depending on whether a device enabled client application is used or a web browser enabled client application is used. At Step 200, the client application may be launched by the subscriber on a portable device or a web browser. If a device enabled client application is used (“Device” Step 210) the application client may ascertain the current location of the device. Certain portable communication devices may receive and/or determine geographic location information that may be accessed via the device's core location framework. For example, such devices may include global positioning system (“GPS”) circuitry and/or may monitor signals transmitted by cell phone towers to triangulate the current position of the device. Through the use of applications developed through standard Software Development Kits (“SDK”) provided by the device vendor such as the herein device enable client application, the application may collect this location information in approximate latitude and longitude.

If a web enabled client application is used (“Web” Step 210) or Step 220 has been completed, in Step 230 the system may authenticate the subscriber. In one aspect, during authentication Application Server 120 may receive a device ID from the device enabled application client or a user identifier and password from the web browser enabled client. The device ID may include an internal programmatically accessible number or device identifier that may uniquely define the device with reduced or no likelihood of duplication or spoofing of the identifier. The user identifier for web browser enabled logins may include the subscriber's telephone number, a unique user name, an email address, or any other identifier that may uniquely define the subscriber to Application Server 120. The parameters passed for these requests as well as other requests to Application Server 120 may be made through any of several transport methods over the IP Network 150. These protocol requests may include Simple Object Access Protocol (“SOAP”) requests, Extensible Markup Language (“XML”) requests, Hypertext Transfer Protocol (“HTTP”) GET requests, or HTTP POST requests.

Once authenticated, the application may then perform further function calls described below, at Step 240, based on user input to the application interface. Multiple function calls may be requested in an application session. The application client may also programmatically call the device's core location framework at Step 220, for example, when a particular function requests updated location information or when a location has not been collected in a predetermined period of time, in which case the location information may no longer be considered reliable. The time parameter for location updates may be global for all subscribers or may be specific for each subscriber. Function requests may programmatically call the device's address book framework 250 to retrieve data related to the subscriber's contacts for use within the client application. At Step 260, the application may terminate, for example, at the subscriber's request.

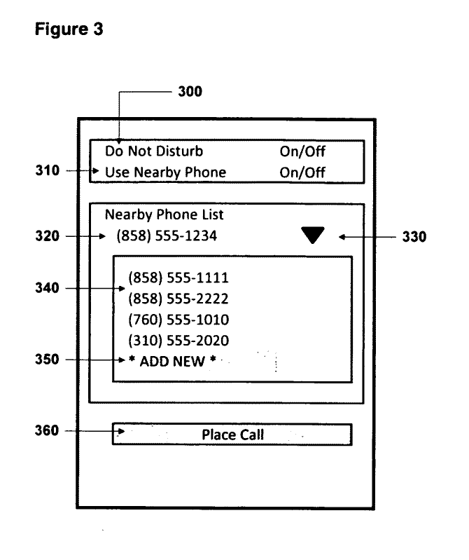

As shown in FIG. 3, the application interface for the device enabled client application and/or the web browser enabled client application may include configurable parameters. Parameter Do Not Disturb (On/Off) 300 allows the user to have calls to the subscriber's phone number routed to a phone (“Off” Do Not Disturb) or to not have calls routed to a phone (“On” Do Not Disturb) in which case the calls may be routed to voice mail or other known Interactive Voice Response (“IVR”) services. If calls are being routed to a phone (“Off” Do Not Disturb), then parameter Use Nearby Phone (On/Off) 310 allows for calls to be routed to the designated portable device (“Off” Use Nearby Phone) or to be routed to a phone number determined to be “near” (“On” Use Nearby Phone). If using a nearby phone (“On” Use Nearby Phone), calls may be routed to the phone number listed as Current Nearby Phone 320.

Subscribers may choose to change the Current Nearby Phone manually by using application button 330 to access a list of nearby phone numbers 340 that may have been previously entered or used by the subscriber. A phone may be considered nearby by the application by determining the subscriber's current location through the device's core location framework, approximating a geographic circle from the device's location, and determining whether the stored longitude and latitude for previously entered or used phone numbers are within this geographic circle. This approximated circle may be determined through calculations to use geographic points at a predetermined distance from the device in many directions and connecting these points to make a polygon or approximated geographic circle. The distance away from the device or radius of the circle may be a fixed distanced or may be a user definable distance. Phone numbers that are determined to be within the geographic circle may be provided on the list of nearby phone numbers 340 and may be ranked, for example, by listing shortest distance first and greatest distance last or most recently used first and least recently used last. A subscriber may also add a new number 350 if the desired phone number is not already on the list, as described in more detail below.

Also a new Current Nearby Phone may be proposed or dynamically updated by the application by determining the most appropriate phone, which may be the closest phone or the most recently used phone. The client application may determine the closest number by accessing the subscriber's current location through the device's core location framework and comparing the current location to stored locations of the phones on the nearby phone numbers list 340. If a new number is proposed, then the subscriber may then be prompted as to whether they would like this new number to be assigned to the Current Nearby Number 320.

Also, as shown of FIG. 3, the application interface may also contain an application button 360 to place outbound calls. This button may then invoke an additional Contact List interface.

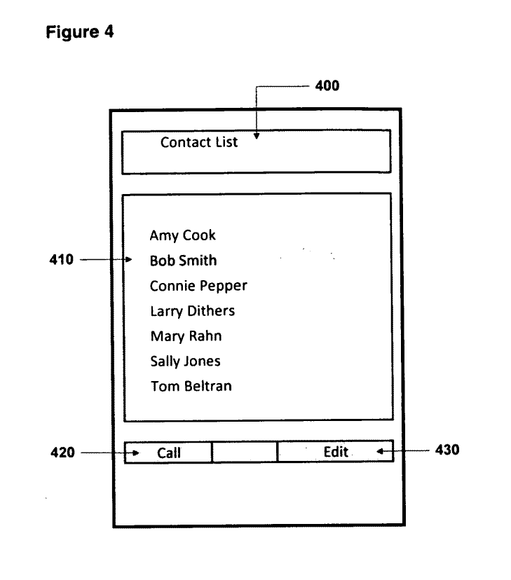

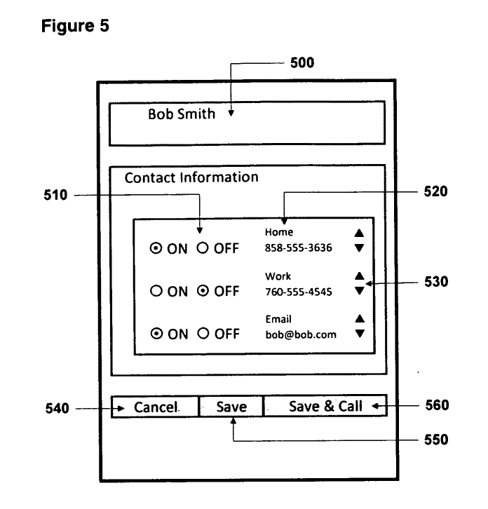

As shown in FIG. 4, the additional Contact List interface invoked by application button “Place Call” 360 may display a list of contacts 400 ascertained by one of two methods depending on the application. If a device enabled client application is being used, a function call to the device's address book framework may be made to retrieve a current list of contacts. If a web enabled client application is being used, a function call to Application Server 120 may be made to retrieve the most recently stored data. A contact on the list may be selected or placed in focus 410. In this example the contact in focus is “Bob Smith”. With “Bob Smith” in focus, when using a web enabled client application, application button “Call” 420 may initiate a function to place a telephone call from Application Server 120 to the subscriber's active phone number. Once the call has been answered by the subscriber, Application Server 120 may join the call to another call placed from the Application Server 120 to “Bob Smith”'s phone number ascertained by other stored parameters, i.e., the active telephone number for “Bob Smith”. With “Bob Smith” in focus, when using a device enabled client application, application button “Call” 420 may initiate a call from the device to Application Server 120. Application Server 120 may then join the call to another call placed to “Bob Smith”'s phone number. In either case, the caller displayed to Bob Smith may be the subscriber's phone number. Also, on an additional Contact Information interface shown in FIG. 5 and discussed below, the stored parameters may be reviewed and updated for the contact in focus by application button “Edit” 430.

### Attempting Multiple Contact Points for a Contact

In one aspect, the system may provide the user with the ability to attempt to reach a contact using multiple contact points, such as telephone numbers and email addresses. If a call to a contact at a first contact point is not answered, a busy signal is detected, or voicemail is reached, then the application may attempt to call additional contact points associated with the contact based on parameters stored in connection with contact. Also, one or more email addresses may be stored for the contact. Application Server 120 may route the subscriber to a voicemail prompt where the subscriber may leave a message and email the message to the contact's email address as an audio file attachment that may be played through common software media players. In one aspect, audio files may be encoded as Waveform (“WAV”), MPEG-1 Audio Layer 3 (“MP3”), or Windows Media Audio (“WMA”) formats. In another aspect, audio messages may be transcribed to text through a known function and the text included in the body of the email.

As shown in FIG. 5, the Contact Information interface invoked by application button “Edit” 430 in FIG. 4 may display additional information about the contact including Name 500, one or more contact numbers and/or email addresses with a corresponding label 520 that may be ascertained from a function call to the device's address book framework and/or a function call to Application Server 120 to retrieve the most recently stored data. Each phone number or email address on the phone number/email address list 520 may contain an additional status parameter 510. This status may be either “On” or “Off”.

In this example, phone number “858-555-3636” labeled “Home” and email address “bob@bob.com” have a status of “On”. Phone number “760-555-4545” labeled “Work” has a status of “Off”. Each phone number or email address on the phone number/email address list may also contain a position. The position parameter may rank the phone numbers and email addresses from first to last and display the listings with the first listed at the top of the display and last at the bottom of the display. If more entries are available than may be displayed at one time, the subscriber may scroll down through the list without affecting the order of the list. The subscriber may also change the position of each entry by one position up or one position down using control buttons 530. Application Button “Cancel” 540 may cancel any modifications made while on this additional interface and return control to the previous interface. Application Button “Save” 540 may save any modifications made while on this additional interface and return control to the previous interface. Application Button “Save & Call” 560 may save any modifications made while on this additional interface and place phone calls to the subscriber and contact outlined above.

In this example, once the user has elected to call “Bob Smith”, by activating Call 420 or Save and Call 560, the system may first attempt to contact “Bob Smith” at contact point “Home” at “858-555-3636” because that contact point is in the first position and the status 510 for that contact point is set to “ON”. If there is no answer after a predetermined number of rings, or a busy signal is encountered on “Home” “858-555-3636”, then Application Server 120 may then look to the next contact point, in this case “Work” located in the second position. Because the status for contact point “Work” is set to “OFF”, the system may not attempt to use that contact point. The system may then look to contact point “Email” in the third position, set to “ON”, and may prompt the subscriber to leave an audio message as described above. This audio message may then be emailed to the address for the “Email” contact, in this case “bob@bob.com”.

In the above-example, if the call to “Home” at “858-555-3636” was answered by voicemail, then the subscriber may move on to the next position in the list by performing a predetermined operation, for example, by pressing the pound key (“#”) on their phone. The Application Server 120 may detect the dual-tone multi-frequency (“DTMF”) for the pound key and proceed by disconnecting the current call from “Home” at “858-555-3636” while leaving the subscriber connected to the Application Server 120 as it attempts to contact using the next position. Continuing with the above-example, if the call proceeded to contact point “Email” and the subscriber was prompted to leave an audio message, the subscriber may similarly move on to the next position in the list by performing a predetermined operation, for example, by pressing “#”. If there are no further positions on the list, as with this example, the Application Server 120 may then proceed by terminating and further processing and disconnecting the subscriber.

### Functions Called by Device Application Client

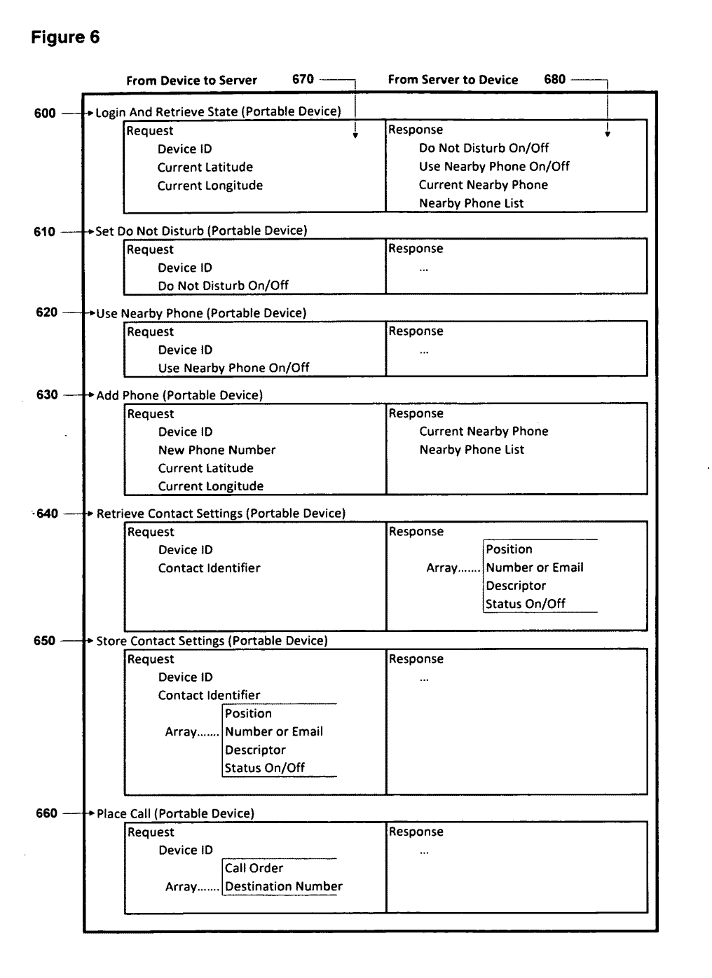

As shown in FIG. 6, the functions called from the device enabled application client may pass parameters to and receive parameters from Application Server 120. Functions may include a Request 670 and/or a Response 680. The Request 670 may be any parameters sent from the application client to Application Server 120 and Response 680 may be any parameters sent back from Application Server 120 to the client. In one aspect, functions may include Login and Retrieve State (Portable Device) 600, Set Do Not Disturb (Portable Device) 610, Use Nearby Phone (Portable Device) 620, Add Phone (Portable Device) 630, Retrieve Contact Settings (Portable Device) 640, Store Contact Settings (Portable Device) 650, and Place Call (Portable Device) 660.

Login and Retrieve State (Portable Device) 600 may send requests including parameters such as “Device ID”, “Current Latitude”, and “Current Longitude” of which the latter two may be ascertained through Step 220 as described above. Responses 680 sent back to the application client may include the current saved settings for “Do Not Disturb On/Off”, “Use Nearby Phone On/Off”, “Current Nearby Phone”, and “Nearby Phone List” to be displayed to the subscriber on the application interface.

If a subscriber changes the setting for Do Not Disturb 300, shown in FIG. 3, on the application interface, then function Set Do Not Disturb (Portable Device) 610 may be invoked sending request parameters “Device ID” and the modified “Do Not Disturb On/Off” from the device to Application Server 120. Response parameters may not be required.

If a subscriber changes the setting for Use Nearby Phone 310, shown in FIG. 3, on the application interface, then function Use Nearby Phone (Portable Device) 620 may be invoked sending request parameters “Device ID” and the modified “Use Nearby Phone On/Off”. Response parameters may not be required.

If a subscriber adds a new phone number 350, shown in FIG. 3, on the application interface, then function Add Phone (Portable Device) 630 may be invoked. This function may also call the device's core location framework, Step 220, to ascertain the current location of the portable device and use the portable device's latitude and longitude for the location of the phone number added, thereby sending request parameters “Device ID”, “New Phone Number”, “Current Latitude”, “Current Longitude” to define the new phone number and location of that phone number. In another aspect, the new phone number's location may also be derived by subscriber input of address or latitude and longitude. In another aspect, a known reverse look up function on the phone number may also be called to ascertain the location of the phone number. Response parameters may include proposed or updated “Current Nearby Phone” and an updated “Nearby Phone List”.

If a subscriber accesses the Contact Information interface through the device enabled client application, function Retrieve Contact Settings (Portable Device) 640 may be invoked. This function may also call the device's address book framework, as shown in Step 250 in FIG. 2, to retrieve contact information. Request parameters “Device ID” and “Contact Identifier” may be sent to Application Server 120. Response parameters may include an array of parameters, one entry per contact phone number/email address for the contact. Array parameters may include “Position”, “Number or Email”, “Label”, “Status On/Off” which then may be displayed on the Contact Information interface.

If a subscriber saves contact information through application button “Save” 550 or “Save & Call” 560 on the Contact Information, then interface function Store Contact Settings (Portable Device) may be invoked sending request parameters “Device ID”, “Contact Identifier”, and an array of parameters, one entry per contact/email address provide for the contact. Array parameters may include “Position”, “Number or Email”, “Label”, “Status On/Off”. Response parameters may not be required.

If a subscriber places a call through application button “Call” 420 on the Contact List interface or application button “Save & Call” 560 on the Contact Information application interface, then function Place Call (Portable Device) 660, may be invoked sending request parameters “Device ID” and an array of parameters, one entry per active contact phone number/email address for the contact. Array parameters may include “Call Order” and “Destination”. “Call Order” may be the order in which calls are be attempted and “Destination” may be the phone number being called or an email address associated for the contact.

### Functions Called by Web Browser Client

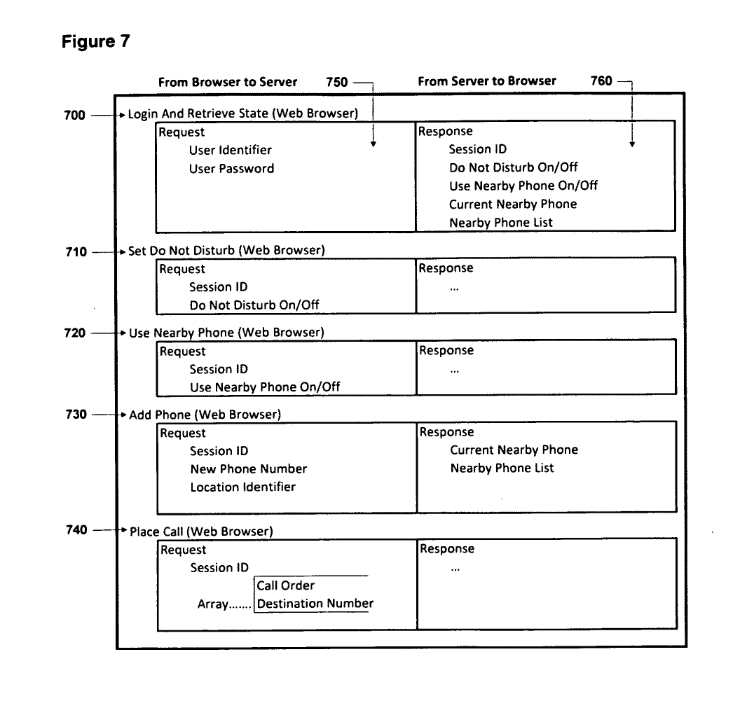

As shown in FIG. 7, the functions called from the web browser enabled application client may pass parameters to Application Server 120 and Application Server 120 may pass parameters back. Functions may include Login and Retrieve State (Web Browser) 700, Set Do Not Disturb (Web Browser) 710, Use Nearby Phone (Web Browser) 720, Add Phone (Web Browser) 730, and Place Call (Web Browser) 740 and may be defined as having a Request 750 and a Response 760. The request may be any parameters sent from the application client to Application Server 120 and the response may be any parameters sent back from Application Server 120 to the client.

Login and Retrieve State (Web Browser) 700 may send requests including parameters such as “User Identifier” and “User Password”. Responses sent back to the application client may include the current saved settings for “Do Not Disturb On/Off”, “Use Nearby Phone On/Off”, “Current Nearby Phone”, and “Nearby Phone List” to be displayed to the subscriber on the application interface. Also response parameter “Session ID” may also be sent which may be generated through standard web session management schemes and techniques including, but not limited to, software tokens and session cookie handling.

If a subscriber changes the setting for Do Not Disturb 300, shown in FIG. 3, on the application interface, function Set Do Not Disturb (Web Browser) 710 may be invoked sending request parameters “Session ID” and the modified “Do Not Disturb On/Off”. Response parameters may not be required.

If a subscriber changes the setting for Use Nearby Phone 720 on the application interface, function Use Nearby Phone (Web Browser) 720 may be invoked sending request parameters “Session ID” and the modified “Use Nearby Phone On/Off”. Response parameters may not be required.

If a subscriber adds a new phone number 350, shown in FIG. 3, on the application interface, function Add Phone (Web Browser) 730 may be invoked. This function may retrieve a location identifier placed on the computer through standard web session management schemes during the first session invoked from a particular computer. This location identifier may be a unique number or code generated by Application Server 120 to identify the computer to the Application Server 120 on subsequent function calls during the present or any future sessions. It may be assumed the new phone number added is in the same geographical area as the computer used to navigate to the web browser enabled client application, thereby sending request parameters “Session ID”, “New Phone Number”, and “Location Identifier” to define the new phone number and location of that phone number. Response parameters may include proposed or updated “Current Nearby Phone” and an updated “Nearby Phone List”.

If a subscriber places a call through application button “Call” 420, shown in FIG. 4, on the Contact List interface or application button “Save & Call” 560, shown in FIG. 5, on the Contact Information application interface, function Place Call (Web Browser) 740, may be invoked sending request parameters “Session ID” and an array of parameters, one entry per active contact phone number/email address for the contact. Array parameters may include “Call Order” and “Destination” “Call Order” may be the order in which calls will be attempted and “Destination” may be the phone number being called or an email address associated for the contact.

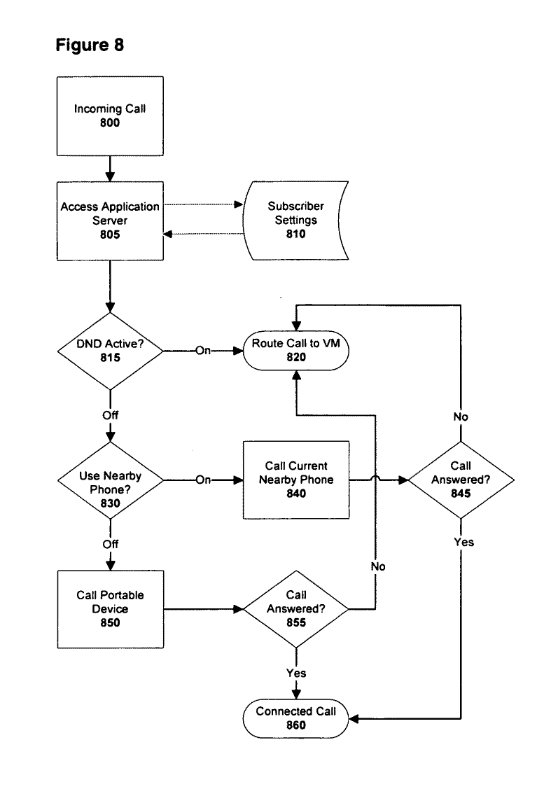

As shown in FIG. 8, an incoming call may be placed from any communication device, such as a telephone connected to the PSTN, to the subscriber telephone number at Step 800. The call may be received by Application Server 120 at Step 805. Application Server 120, at Step 810, may access the subscriber settings previously ascertained through the device enabled client application and/or the web browser enabled client application. If “Do Not Disturb On/Off” is active (“On” Step 815), then the caller may be routed at Step 820 to voice mail or another IVR service, and the routing process may be complete. If “Do Not Disturb On/Off” is inactive (“Off” Step 815) Application Server 120 may then determine at Step 830 whether “Use Nearby Phone On/Off” is active. If active, (“On” Step 830), then Application Server 120 may then at Step 840 attempt to call the “Current Nearby Phone”. If the call to the “nearby” phone is answered (“Yes” Step 845), then that call is connected to the incoming call at Step 860, and the caller and subscriber may then engage in conversation. If the call is not answered (“No” Step 845), then at Step 820 the caller may be routed to voice mail or any other IVR service.

In another aspect, the incoming call may be made to the telephone number of the portable device, rather than the subscriber number. In that case, the portable device may forward the call to the Current Nearby Phone 320, using traditional call-forwarding methods, such as an asterisk “*” code.

Returning to FIG. 8, if “Use Nearby Phone” is inactive (“Off” Step 830) Application Server 120 may then at Step 850 call the portable device where the device enabled client application resides. If the call is not answered (“No” Step 855), then the caller may then at Step 820 be routed to voice mail or another IVR service. If the call to the portable device is answered (“Yes” Step 855), then the incoming call by the caller and the call placed by Application Server 120 may be connected at Step 860.

Adding a Number to Nearby List

In one aspect, the system may provide the subscriber with the ability to add a phone number to the list of nearby phone numbers 340 by calling the subscriber phone number at Step 800 from the phone that is to be added to the list. The call may be received by Application Server 120 at Step 805. Application Server 120, at Step 810, may access the subscriber settings previously ascertained through the device enabled client application and/or the web browser enabled client application. If the subscriber performs a predetermined operation, for example, by pressing the asterisk key (“*”) on their phone, Application Server 120 may then prompt for a user password. This password may be the same as “User Password” used for function Login and Retrieve State (Web Browser) 700 or the telephone keypad equivalent of “User Password”. It may be also be any stored number designed to restrict access to only subscribers who know the password. Once a valid password has been entered, Application Server 120 may then use the Caller Number Identification (“CNID”) of the placed call as a new entry in the list of nearby phones 340.

### Switching Active Call

In another aspect, the system and method of the present disclosure may allow for the switching of parameter values in the device enabled client application or web browser enabled client application to affect the status or routing of an active connected call on the subscriber phone number. For example, if a subscriber was currently on a phone conversation on the Current Nearby Phone and wanted to switch the call over to the portable communication device, then the subscriber may do so. The subscriber may also switch the call from the portable communication device to the Current Nearby Phone or from one nearby phone to another nearby phone.

Switch Call from Portable Device to Nearby Phone

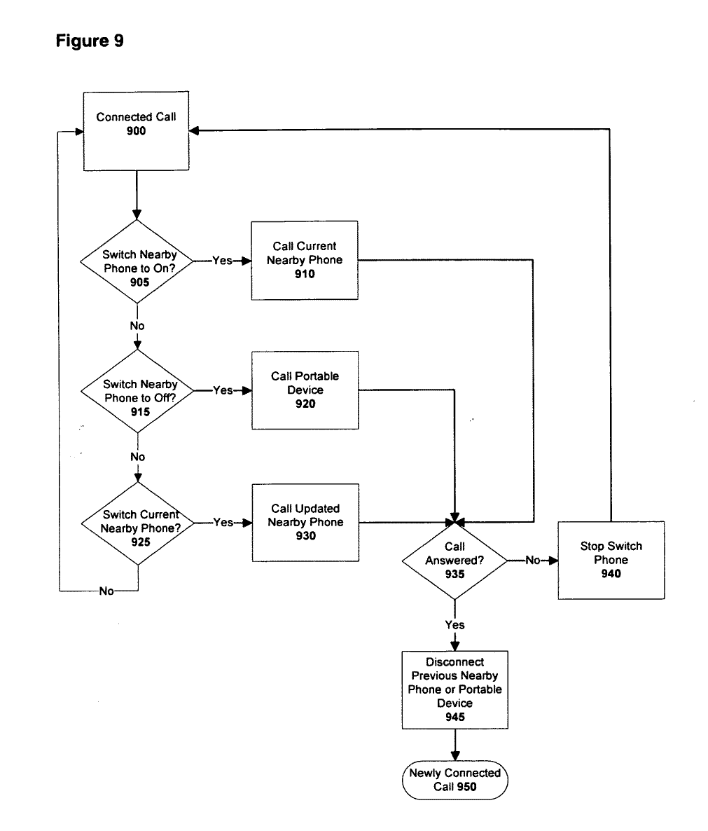

As shown in FIG. 9, if a subscriber is on an active call 900 and predetermined parameters are updated through the device enabled or web browser enabled client application, then the active call may be switched between communication devices, for example, from a portable communications device to a nearby phone or vice versa. The Application Server 120 may first determine whether the “Use Nearby Phone On/Off” parameter has been switched from “Off” to “On” at Step 905. If so, (“Yes” Step 905) Application Server 120 may then at Step 910 attempt to call the “Current Nearby Phone”. If the call is answered (“Yes” Step 935) Application Server 120 may then at Step 945 connect the active call with the call placed by Application Server 120 then disconnect the portable device from the conversation affectively switching the call from the portable device to the “Current Nearby Phone” resulting in a new connected call at Step 950. If the call is not answered (“No” at Step 935), then Application Server 120 at Step 940 may stop any attempt to transfer the call resulting in resumption of the original connected call at Step 900.

Switch Call from Nearby Phone to Portable Device

If the “Use Nearby Phone On/Off” parameter has not been switched from “Off” to “On” (“No” Step 905) then Application Server 120 may then determine whether the “Use Nearby Phone On/Off” parameter has been switched from “On” to “Off” at Step 915. If so, (“Yes” Step 915) Application Server 120 may then attempt to call the portable device where the device enabled client application resides at Step 920. If the call is answered (“Yes” Step 935) Application Server 120 may then at Step 945 connect the active call with the call placed by Application Server 120 to the portable communication device, then disconnect the active “Current Nearby Phone” from the conversation, thereby effectively switching the call from the “Current Nearby Phone” to the portable device and resulting in a rerouted or newly connected call 950.

If the “Use Nearby Phone On/Off” parameter has not been switched from “On” to “Off” (“No” Step 915) then Application Server 120 may then determine whether the “Current Nearby Phone” has been updated at Step 925. If so, (“Yes” Step 925) then Application Server 120 may then attempt to call the updated “Current Nearby Phone” at Step 930. If the call is answered (“Yes” Step 935) Application Server 120 may then at Step 945 connect the active call with the call placed by Application Server 120 then disconnect the active “Current Nearby Phone” from the conversation affectively switching the call from the “Current Nearby Phone” to the updated “Current Nearby Phone” and resulting in a newly connected call 950.

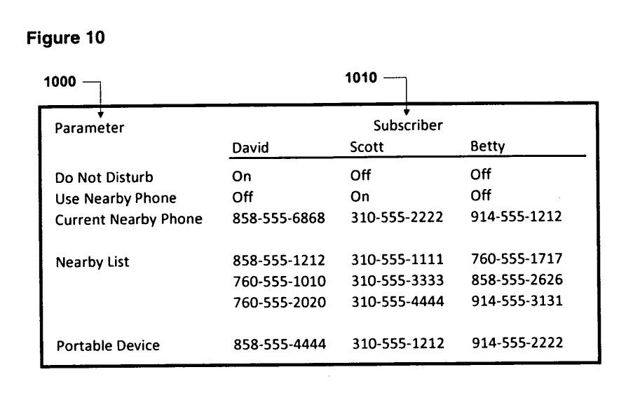

As shown in FIG. 10, subscribers 1010 may have different parameter values 1000. The example in FIG. 10 shows three subscribers “David”, “Scott”, and “Betty”, along with corresponding parameters for each. According to one aspect of the system and method of the present disclosure, if a call was placed to David's subscriber telephone number, then the system may route the caller to voicemail since parameter “Do Not Disturb” has a value of “On”. If a call was placed to Scott's subscriber telephone number, then the caller may be routed to phone number “310-555-2222” since “Do Not Disturb” has a value of “Off”, “Use Nearby Phone” has a value of “On”, and the “Current Nearby Number” is “310-555-2222”. If a call was placed to Betty's subscriber telephone number, then the call may be routed to Betty's portable device since “Do Not Disturb” has a value of “Off” and “Use Nearby Phone” has a value of “Off”.

If “Betty” was on an active call through her subscriber number on her portable device and wanted to switch the call to her Current Nearby Phone “914-555-1212”, Betty may be able to do so by changing the value of parameter “Use Nearby Phone” to “On” through the client application interface. This may initiate Application Server 120 to call Betty on the “Current Nearby Phone” at “914-555-1212”. Once Betty has answered this call to the current nearby phone, she may be connected with the active phone call and Betty's portable device may be disconnected from the call.

If “Scott” was on an active call through his subscriber number on his Current Nearby Phone “310-555-2222” and wanted to switch the call to another nearby phone, for example, “310-555-3333” shown second in the “Nearby List”, Scott may do so by changing the value of parameter “Current Nearby Phone” to “310-555-3333” through the client application interface. This may initiate Application Server 120 to call Scott on “310-555-3333”. Once Scott has answered this call, he may be connected with the active phone call and “310-555-2222” may be disconnected from the call.

Although illustrative embodiments have been shown and described herein in detail, it should be noted and will be appreciated by those skilled in the art that there may be numerous variations and other embodiments that may be equivalent to those explicitly shown and described. For example, the scope of the present invention is not necessarily limited in all cases to execution of the aforementioned steps in the order discussed. Unless otherwise specifically stated, terms and expressions have been used herein as terms of description, not of limitation. Accordingly, the invention is not to be limited by the specific illustrated and described embodiments (or the terms or expressions used to describe them) but only by the scope of claims.

What is claimed is:

1. A method for forwarding calls, comprising,
a. selecting a target telephone number based on a geographic location of a communication device;
b. receiving at a server a first call to a first telephone number;
c. initiating a second call from the server to the target telephone number; and
d. connecting the first call and the second call.

2. The method of claim 1, wherein step a) further comprises, selecting the target telephone number from one or more candidate telephone numbers associated with geographic locations.

3. The method of claim 2, wherein the target telephone number is associated with a geographic location closest to the geographic location of the communication device

4. The method of claim 2, further comprising, transmitting the one or more candidate telephone numbers to the communication device, where the candidate telephone numbers are ranked in order of distance from the geographic location of the communication device.

5. The method of claim 2, further comprising, transmitting the one or more candidate target telephone numbers to the communication device, and wherein a user selects the target telephone number from the one or more candidate telephone numbers.

6. The method of claim 2, wherein the user adds a new telephone number to the one or more candidate telephone numbers.

7. The method of claim 6, wherein the new telephone number is associated with the geographic location of the communication device.

8. The method of claim 6, wherein the new telephone number is associated with a geographic location input by the user.

9. The method of claim 6, wherein the new telephone number is associated with a geographic location determined by a reverse telephone number look-up.

10. The method of claim 1, wherein step a) further comprises, selecting the target telephone number from one or more candidate telephone numbers associated with geographic locations within a predetermined distance of the geographic location of the communication device.

11. The method of claim 1, wherein the target telephone number is selected at the communication device.

12. The method of claim 1, wherein the target telephone number is selected by a user via a web interface.

13. The method of claim 1, further comprising, receiving at the server the geographic location of the communication device, and wherein the target telephone number is selected at the server.

14. The method of claim 1, wherein a user selects to automatically direct to voicemail calls to the first telephone number.

15. A method for transferring a call between a user at a first communication device and a third-party, comprising:
a. selecting a second communication device based on a geographic location of the first communication device;
b. receiving at a server, a transfer signal from the user;
c. initiating a second call from the server to the second communication device in response to the transfer signal; and
d. connecting the third-party to the second communication device when the second call to the second communication device is answered.

16. The method of claim 15, wherein the transfer signal originates from a cellular phone.

17. The method of claim 15, wherein the transfer signal originates from a web interface.

18. The method of claim 15, wherein the second communication device is selected by the user.

19. The method of claim 15, wherein step a) further comprises, selecting the second communication device from one or more candidate communication devices associated with geographic locations.

20. The method of claim 15, wherein the first communication device is one of a cellular phone and a POTS phone and the second communication device is the other of the cellular phone and the POTS phone.

21. A method for communicating with a contact, comprising:
a. selecting the contact at a communication device;
b. transmitting data corresponding to the contact from the communication device to a server;
c. initiating a first call from the server to a first contact point for the contact;
d. terminating, after a predetermined event, the call from the server to the first contact point; and
e. initiating a second call from the server to a second contact point for the contact.

22. The method of claim 21, wherein data corresponding to the contact comprises two or more contact points ranked in order of contact preference.

23. The method of claim 21, wherein the contact point is one of a telephone number and an email address.

24. The method of claim 21, wherein data corresponding to the contact comprises an email address and the server records an audio file from a caller and transmits the audio file to the email address.

25. The method of claim 21, wherein the communication device is one of a cellular phone and a web interface.

26. The method of claim 21, wherein the predetermined event is one of a busy signal, a voicemail indicator, and a ring time out.
